(19) United States
(12) Patent Application Publication
(10) Pub. No.: US 2024/0217346 A1
(43) Pub. Date: Jul. 4, 2024

(54) APPARATUS FOR FREIGHT TRANSPORTATION

(71) Applicant: F. Jay Andress, Cincinnati, OH (US)

(72) Inventor: F. Jay Andress, Cincinnati, OH (US)

(21) Appl. No.: 18/440,040

(22) Filed: Feb. 13, 2024

Related U.S. Application Data
(63) Continuation-in-part of application No. PCT/US23/65727, filed on Apr. 13, 2023.
(60) Provisional application No. 63/342,655, filed on May 17, 2022.

(51) Int. Cl. B60L 13/00; B61B 13/04; B61C 13/04; B65G 63/00; B65G 67/54; E01B 25/26; G06Q 10/083

(52) U.S. Cl. CPC B60L 13/006; B61B 13/04; B61C 13/04; B65G 63/004; B65G 67/54; E01B 25/26; G06Q 10/083; B60L 2200/26

(57) ABSTRACT

The present invention discloses an apparatus for freight transportation. The apparatus comprising an electrified rail network, and a freight carrier mounted on the electrified rail network. The freight carrier is adjustable in length and comprises locking pins at opposing sides of the freight carrier. The freight carrier adjusts a location of the locking pins to match a length of the container. An attachment device receives and raises the container towards the carrier so that a connection holes at a top of the container connects to the locking pins under the freight carrier. A drive wheel assembly disposed at the freight carrier provides drive required to facilitate movement of the freight carrier along the rail network. A computing device in communication with the freight carrier is configured to send signal to the freight carrier to navigate the freight carrier to a destination point, thereby automatically delivering containers to the destination point.

### CROSS-REFERENCE TO RELATED APPLICATIONS

This is a continuation-in-part application, which claims the benefit of priority under 35 U.S.C. § 119(e) to International Patent Application No. PCT/US23/65727, entitled “APPARATUS FOR MOUNTING OF A WHEELED VEHICLE ON AN OVERHEAD TRANSPORT NETWORK filed Apr. 13, 2023, which claims the benefit to U.S. Patent Application Provisional Application Ser. No. 63/342,655, entitled “APPARATUS FOR MOUNTING OF A WHEELED VEHICLE ON AN OVERHEAD TRANSPORT NETWORK,” filed May 17, 2022, the contents of which are hereby incorporated by reference in their entirety for any purpose.

### FIELD OF THE INVENTION

The present disclosure relates generally to transportation, and more particularly, an apparatus for freight transportation.

### BACKGROUND OF THE INVENTION

Monorail transportation systems, and other overhead rail transportation systems, have been proposed as a means for reducing traffic congestion. In a monorail system, a vehicle is typically suspended beneath an overhead rail such that the vehicle is elevated above the ground. By elevating the rail above the ground, the land surface under the rail may be used for standard roadways to increase the volume of traffic that a given area may service, or to permit the land to be used for other purposes.

Monorail transportation systems lend themselves well to mass transit wherein a discrete number of vehicles each capable of holding a large number of people are used, much like subway systems. This approach entails employing a fleet of vehicles, each capable of accommodating substantial passenger loads. Such systems have demonstrated effectiveness in addressing urban mobility challenges by facilitating the efficient movement of a large number of individuals across metropolitan areas.

However, while these existing transportation models showcase promise in managing traffic congestion and streamlining mass transit, there remains a need for novel solutions that specifically address the efficient and flexible transport of goods, including containers, within these infrastructural frameworks. Tailoring transportation systems to cater not only to mass transit for passengers but also to optimize cargo and container logistics stands as a crucial requirement in modern urban landscapes and global trade networks.

Therefore, there is a need for an apparatus for freight transportation such as freight loads and containers.

### SUMMARY OF THE INVENTION

The present invention discloses an apparatus for freight transportation. The apparatus comprising an electrified rail network, at least one attachment device configured to receive a shipping container from a crane, at least one freight carrier mounted on the electrified rail network, at least one drive wheel assembly disposed at the freight carrier and at least one computing device. The freight carrier comprises one or more locking pins at opposing sides of the freight carrier. The freight carrier is adjustable in length. The freight carrier is configured to adjust a location of the locking pins to match a length of the shipping container. The attachment device is configured to move at least one shipping container under the electrified rail network. The attachment device is configured to raise the shipping container so that a connection holes at a top of the shipping container connects to the locking pins under the freight carrier.

The drive wheel assembly is configured to provide drive required to facilitate movement of the freight carrier along the electrified rail network. The computing device is in communication with the freight carrier. The computing device is configured to send signal to the freight carrier to navigate the freight carrier to a destination point, thereby automatically handling shipping containers at a port. The electrified rail network comprises one or more parallel tracks. The electrified rail network comprises one or more spaced apart I-channels that defines the electrified rail network. The apparatus further comprises one or more mechanical switches disposed at the electrified rail network. The mechanical switch is configured to enable the freight carrier to switch between different tracks.

The apparatus further comprises at least one storage area configured to store the freight carrier having the shipping container. The computing device is configured to send signal to the freight carrier to navigate to the storage area and rest at the storage area for a predefined time. The computing device is further configured to send one or more signals to the freight carrier to navigate to a destination point from the storage area at a predefined time. The computing device is further configured to enable the freight carrier to drop the shipping container at the attachment device of the destination point.

The drive wheel assembly comprises an axle supported in the freight carrier, a pair of drive wheels supported on operative ends of the axle, a transmission system coupled to the axle for transmitting a rotary drive to the axle, and a drive motor coupled to the transmission system for providing the rotary drive to the transmission system. The apparatus further comprises positioning sensors in communication with the computing device to determine location of the freight carrier and the shipping container.

In another embodiment, the apparatus comprising an electrified rail network, at least one attachment device configured to receive a container, at least one freight carrier mounted on the electrified rail network, at least one drive wheel assembly disposed at the freight carrier and at least one computing device. The freight carrier comprises one or more locking pins at opposing sides of the freight carrier. The freight carrier is adjustable in length. The freight carrier is configured to adjust a location of the locking pins to match a length of the container.

The attachment device is configured to move at least one container under the electrified rail network. The attachment device is configured to raise the container so that a connection holes at a top of the container connects to the locking pins under the freight carrier. The drive wheel assembly is configured to provide drive required to facilitate movement of the freight carrier along the electrified rail network. The computing device is in communication with the freight carrier. The computing device is configured to send signal to the freight carrier to navigate the freight carrier to a destination point, thereby automatically delivering containers to the destination point.

The electrified rail network comprises one or more parallel tracks. The electrified rail network comprises one or more spaced apart I-channels that defines the electrified rail network. The apparatus further comprises one or more mechanical switches disposed at the electrified rail network. The mechanical switch is configured to enable the freight carrier to switch between different tracks.

The apparatus further comprises at least one storage area configured to store the freight carrier having the container. The computing device is configured to send signal to the freight carrier to navigate to the storage area and rest at the storage area for a predefined time. The computing device is further configured to send signal to the freight carrier to navigate to a destination point from the storage area at a predefined time, thereby delivering the container at a time desired by a receiver of the container. The computing device is further configured to enable the freight carrier to drop the container at the attachment device of the destination point. The apparatus further comprises positioning sensors in communication with the computing device to determine location of the freight carrier and the container.

The above summary contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the following figures and detailed written description.

### BRIEF DESCRIPTION OF DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates a schematic front view of an apparatus for facilitating mounting of a wheeled vehicle on an overhead monorail network, according to an embodiment of the present disclosure.

FIG. 2 illustrates a schematic front view of the apparatus with support wheels retracted, according to an embodiment of the present disclosure.

FIG. 3A and FIG. 3B illustrate different top views of the apparatus, according to an embodiment of the present disclosure.

FIG. 4 illustrates a schematic side view depicting the wheeled vehicle mounted on the overhead monorail network, according to an embodiment of the present disclosure.

FIG. 5 illustrates another schematic side view of the apparatus with drive wheels retracted, according to an embodiment of the present disclosure.

FIG. 6 illustrates yet another schematic side view of the apparatus with support wheels retracted, according to an embodiment of the present disclosure.

FIG. 7 exemplarily illustrates a schematic view of a diversion occurring on the monorail, according to an embodiment of the present disclosure.

FIG. 8 illustrates a schematic view of retracting brackets and air bladders used in a drive wheel assembly of the apparatus, according to an embodiment of the present disclosure.

FIG. 9 illustrates a schematic view of linear actuators used to raise and lower support wheels of the apparatus, according to an embodiment of the present disclosure.

FIG. 10 through FIG. 12 illustrate different views of an apparatus for rail freight transportation, in accordance with an embodiment of the present subject matter.

FIG. 13 exemplarily illustrates an environment of an apparatus for freight transportation, according to an embodiment of the present invention.

FIG. 14 exemplarily illustrates a crane dropping a shipping container at the attachment device, according to an embodiment of the present invention.

FIG. 15 exemplarily illustrates an attachment device receiving a shipping container from a crane, according to an embodiment of the present invention.

FIG. 16 exemplarily illustrates the attachment device moving the shipping container upwards and towards a freight carrier of the apparatus of FIG. 13, according to an embodiment of the present invention.

FIG. 17 exemplarily illustrates the freight carrier carrying the shipping container on an electric rail network, according to an embodiment of the present invention.

FIG. 18 exemplarily illustrates the freight carrier carrying the shipping container receiving a signal regarding a destination point to drop off the shipping container, according to an embodiment of the present invention.

FIG. 19 exemplarily illustrates the freight carrier carrying the shipping container reaching the destination point, according to an embodiment of the present invention.

### DETAILED DESCRIPTION OF THE INVENTION

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

All publications, patents and patent applications cited herein, whether supra or infra, are hereby incorporated by reference in their entirety to the same extent as if each individual publication, patent, or patent application was specifically and individually indicated as incorporated by reference.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

As will be appreciated by one having ordinary skill in the art, the methods and compositions of the invention substantially reduce or eliminate the disadvantages and drawbacks associated with prior art methods and compositions.

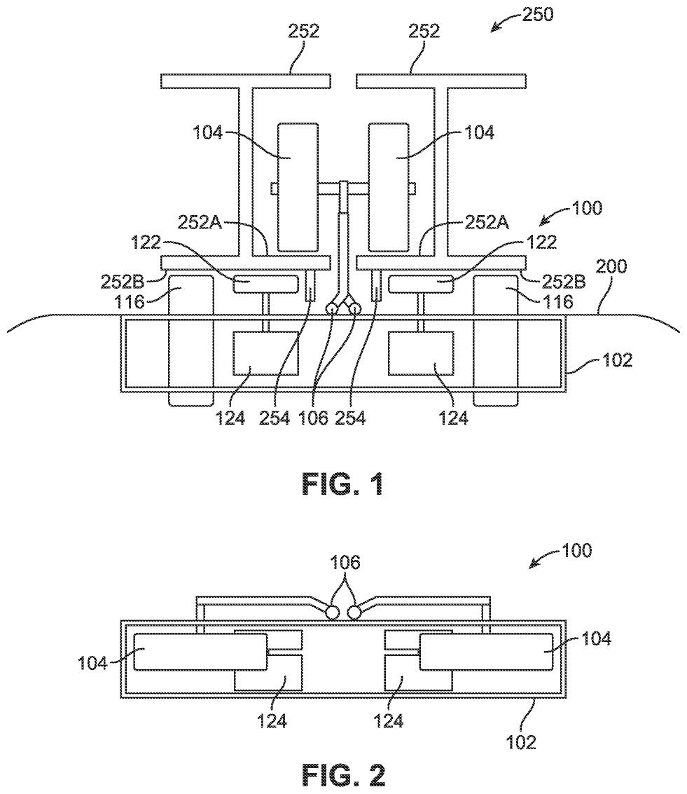

FIG. 1 illustrates a schematic front view of an apparatus 100 for facilitating mounting of a wheeled vehicle 200 on an overhead monorail network 250, according to an embodiment of the present disclosure. It is to be noted that the term “wheeled vehicle”, as used in the present disclosure, is intended to include different kinds of vehicles having at least two or more wheels as well, e.g., cars, mini-bus, motorcycles, trikes, buses, trucks, and the like. In accordance with some exemplary applications, wheeled vehicles such as cars may employ the usage of one apparatus 100, while some larger vehicles such as trucks, buses, and the like may employ the usage of more than one apparatus 100.

In accordance with an embodiment of the present subject matter, the overhead monorail network 250 (hereinafter also referred to as OMN 250) may be a network of rails configured and distributed within a town or a city. In one exemplary embodiment, the overhead monorail network may be provided correspondingly above the conventional road network. In accordance with an embodiment of the present subject matter, the OMN 250 includes two spaced apart I-channels 252 defining a rail structure. Although monorail network 250 is described as being made from a modified I-beam, as will be readily appreciated by those skilled in the art, other structures may be used to manufacture the monorail. However, it is believed that the described modified I-beam structure provides a high strength and inexpensive monorail.

The OMN 250 also includes guide rails 254 extending from bottom surfaces of the I-channels 252. The guide rails 254 allow the vehicle 200 supported on the OMN 250 to take turns along the OMN 250. The turning operation of the vehicle 200 along the OMN 250 is described in the subsequent sections of the present disclosure. In one embodiment, the OMN 250 is comprised of a plurality of connected sections and at least one section is comprised of a plurality of individual interconnected links.

Referring to FIG. 1, vehicle 200 preferably is adapted to travel on ordinary road surfaces when separated from monorail network 250. To this end, vehicle 200 is contemplated to have a standard automobile configuration including road surface wheels and a propulsion system (not shown) operatively interconnected to at least one of the road surface wheels. Further, this propulsion system is preferably independent from drive motor 120 and may be an electric, gasoline or diesel engine and transmission or transaxle as is conventional. However, it is beneficial to use an electric motor for the propulsion system to render vehicle 200 a true zero emission vehicle because of the recent push for such vehicles. With an electric drive unit, vehicle 200 includes a plurality of batteries for powering vehicle 200 when separated from monorail network 250. These batteries may be stored in the bottom and or rear of vehicle 200, although any location throughout vehicle 200 may be used. By using an all-electric vehicle 200 in conjunction with monorail transportation system, travel along monorail network 250 extends the range of vehicle 200. Further, batteries may be charged during travel along monorail network 250. Still further, the life of batteries is extended by reducing the time that vehicle 200 travels independently from monorail network 250, during which time batteries are used, to propelling vehicle 200 to and from monorail transportation system. Batteries may be recharged by a diesel engine/generator, power line (e.g., OMN 250, third rail, etc.), regenerative braking, renewable energy sources (e.g., solar cell, wind turbine), etc.

Referring to FIG. 1, the apparatus 100 comprises an accommodation compartment 102, in accordance with an embodiment of the present subject matter. The accommodation compartment 102, in accordance with an embodiment of the present subject matter, may be configured on the roof of the vehicle 200, while extending into the interior of the vehicle 200. In another embodiment, the accommodation compartment may be configured operatively above the roof of the vehicle 200. The accommodation compartment 102 is the compartment specifically configured to accommodate the different components of the apparatus 100 therewithin. In one embodiment, the accommodation compartment 102 has a rectangular configuration.

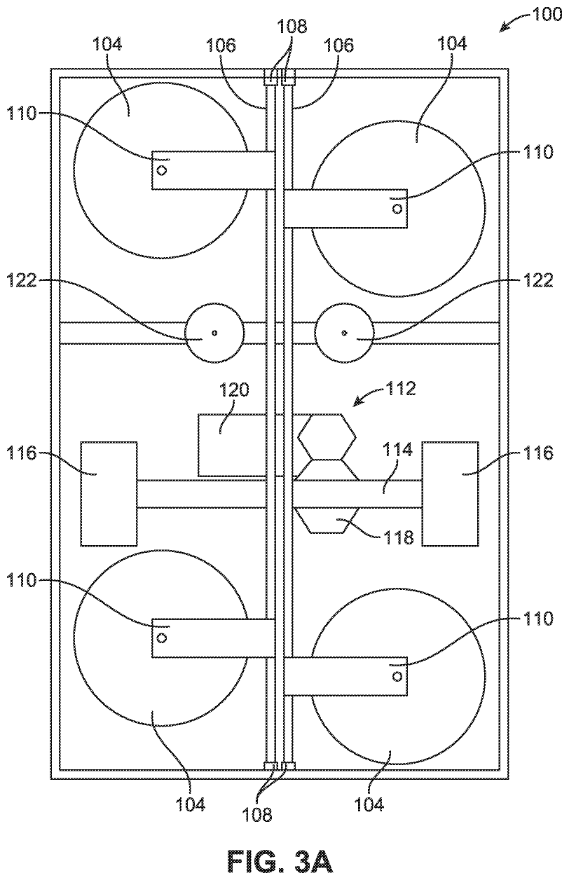

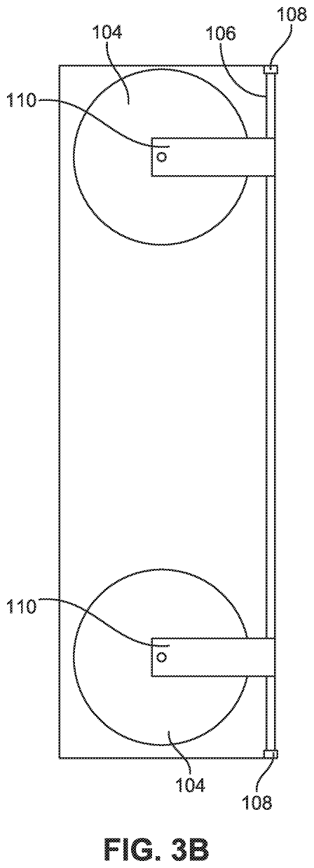

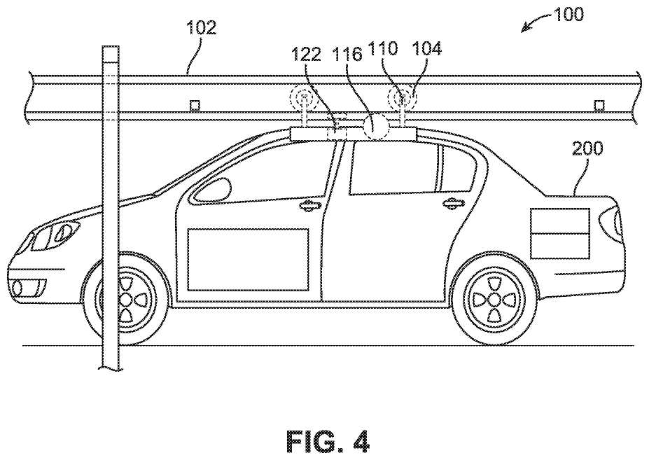

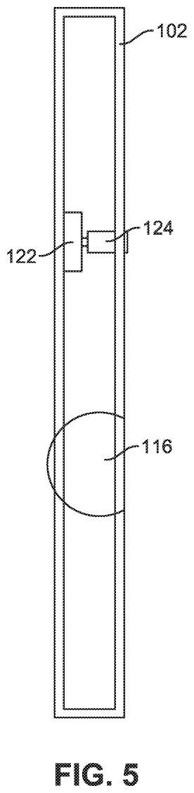

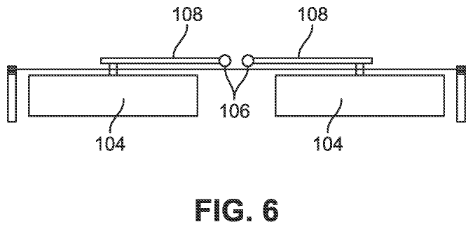

The apparatus 100 further comprises at least one pair of support wheels 104 disposed within the accommodation compartment 102 and configured for facilitating mounting and dismounting of the vehicle 200 on the OMN 250. FIG. 2 illustrates a schematic side view of the apparatus 100 with support wheels 104 retracted, according to an embodiment of the present disclosure. FIG. 3A and FIG. 3B illustrate different top views of the apparatus 100, according to an embodiment of the present disclosure. FIG. 4 illustrates a schematic side view depicting the wheeled vehicle 200 mounted on the overhead monorail network 250. FIG. 5 and FIG. 6 illustrate a side view and a front view of the apparatus 100 as depicted in the schematic top view of FIG. 3, respectively. Referring to FIG. 1 thru FIG. 6, the support wheels 104 of the apparatus 100 are configured for being operable in an extended configuration (as seen in FIG. 1), and a retracted configuration (as seen in FIG. 2, FIG. 3A, FIG. 3B, and FIG. 6). In the extended configuration, the support wheels 104 are raised substantially orthogonally to interface with surfaces 252A of the I-channels 252. More specifically, the surfaces 252A of the I-channels 252 act as contact surfaces for holding the vehicle 200 thereon by means of the support wheels 104.

In one embodiment, the vehicle 200 is supported from monorail network 250 by support wheels 104. Support wheels 104 is preferably movable between a recessed position within the top of vehicle 200 during road travel and an extended position to movably support vehicle 200 from monorail network 250 during travel there along. Similarly, drive wheels 116 are also preferably movable between a recessed position within the top of vehicle 200 during road travel and an extended position for engaging lower surface or underside 252B of monorail network 250 during travel there along. In one or more embodiments, the top of vehicle 200 includes a rectangular accommodation compartment 102 having a length of about 48 inches and a width of about 18 inches and extends rearwardly from just behind the windshield of vehicle 200. The cavity floor is about 9 inches below the top of vehicle 200. Support wheels 104 and drive wheels 116 are located within compartment 102 such that they are substantially hidden from view when in the recessed position. Further, compartment 102 may include a removable or openable cover (not shown) to hide and protect support wheels 104 and drive wheels 116 when vehicle 200 is separated from monorail network 250.

In one embodiment, the support wheels 104 are coupled to a pair of support rods 106. The pair of support rods 106 are rotatably supported within the accommodation compartment 102. In one embodiment, the pair of support rods 106 are supported on protrusions 108 extending inwardly into the accommodation compartment 102 from a wall thereof. In one embodiment, the protrusion 108 are hollow protrusions. In another embodiment, the protrusions 108 may include a ball bearing disposed therein for facilitating smooth rotational movement of the support rods 106 in the protrusions 108 for facilitating the raising and lowering of the support wheels 104.

In one embodiment, the support wheels 104 are coupled to the pair of support rods 106 via support brackets 110. More specifically, one operative end 110A of the support bracket 110 may be coupled to the support rod 106, while other operative end 110B of the support rod 110 may be coupled to the support wheel 104.

Referring to FIG. 1, the apparatus 100 further comprises a drive wheel assembly 112 and 116. The drive wheel assembly 112 comprises an axle 114 supported in the accommodation compartment 102. A pair of drive wheels 116 are supported on operative ends of the axle 114. A transmission system 118 is coupled to the axle for transmitting a rotary drive to the axle 114. A drive motor 120 is coupled to the transmission system for providing the rotary drive to the transmission system 118. More specifically, drive wheels 116 are configured to interface with surfaces 252B of the I-channels 252. The drive wheels 116 are provided with the required drive for translating the vehicle 200 along the OMN 250 via the drive motor 120, wherein the drive motor may be powered via a battery of the vehicle 200 according to an embodiment of the present subject matter. In one embodiment, the drive wheels 116 may be inflatable wheels but other wheels may be used. In another embodiment, the drive wheels 116 have a rubber-like surface to provide traction.

In one embodiment, the OMN 250 is configured to provide electrical power supply to the vehicle 200 for facilitating charging of the vehicle 200 while the vehicle 200 is mounted on the OMN network 250. As such, the battery capacity of the vehicle 200 is not impacted significantly by the constant use of the drive motor 120 for propelling the vehicle 200 along the OMN 250. In one embodiment, the electrical supply is provided from the OMN 250 to a metering device in the vehicle 200, wherefrom the electric supply may then be used by the batteries for charging while being mounted on the OMN 250. In another embodiment, once the batteries of the vehicle 200 are charged, the electrical supply may then be diverted from the OMN 250 to the metering device and then to the drive motor 120. In one embodiment, the electric supply from the rail may be supplied via a metal contact in the support or drive wheels, using a bus bar system or via inductive charging. In one or more embodiments, a single electric conductor may be secured to monorail wherein monorail network 250 itself serves as the second conductor, such as a ground. Further it is contemplated that the electric supply may be alternating current or direct current. Providing an electric supply along monorail network 250 obviates the need for an expensive infrastructure of charging stations. Rather, the vehicles traveling on monorail network 250 can draw the power from the monorail network 250 for propelling vehicle 200, which in turn is used for charging batteries which propel vehicle 200 during road travel.

In one embodiment, the OMN 250 further includes one or more power supplies electrically connected to a source of electric power and the rails; and the power supplies are configured to rectify and reduce a voltage of electric power from the source of electric power. In another embodiment of the disclosed technology, the power supplies are configured to rectify and reduce the voltage of electric power from the source of electric power to about 400 volts to about 750 volts. In another embodiment of the disclosed technology, the vehicle further includes a converter electrically connected to the first electrical pickup and the electric motor and configured to, during operation, convert a voltage of electric power from at least one of the power supplies to an operating voltage of the electric motor.

In one embodiment, the power supply device for a conventional railway usually is referred to as a substation, which reduces the very high voltage of the electricity delivered by the utility company to the various lower voltages required by different trains. These substations essentially are large transformer/rectifiers typically installed by the electrical utility; and are spaced apart in relatively large intervals along the railway. In some embodiments of the OMN 250, the DC power is provided through relatively simple power conversion hardware referred to herein as power supplies. The power supplies are compact transformer/rectifier units that, for example, convert high-voltage AC power from the local electric grid or other sources into a lower DC voltage that can be used to power the electric drive motor 120 inside the vehicles 200. More specifically, the power supplies transform and rectify high-voltage AC power, such as 125 k VAC, to a voltage, such as 750 VDC or 400 VDC, that is low enough to be relatively safe for maintenance workers and others in direct proximity to the OMN 250, but high enough to permit the vehicles 200 to operate efficiently. The power supplies can be located anywhere along the OMN 250 at any suitable interval or spacing.

In one or more embodiments, the invention relates to a novel system for transporting at least one passenger or cargo load, wherein the system has at least one first track, wherein at least one vehicle is located on the at least one first track, on which the at least one vehicle can travel and be guided, characterized in that the vehicle and the at least one first track are operatively connected by a drive, wherein the drive is designed in particular as a contactless linear motor, wherein the at least one vehicle has a control device for influencing the speed of the at least one vehicle on the at least one first track. In one embodiment, contactless linear motors, in particular Linear Induction Motors (LIM) can be utilized. An example of a LIM being used to propel a train is provided in U.S. Pat. No. 3,233,559 (incorporated by reference).

In one or more embodiments, the electric motor has an automatic second control device, which transmits corresponding signals to the linear electric motor on the basis of the distance of two or more vehicles from one another, the speed and/or the course of the vehicle, in order to accelerate, brake or stop the travel speed of the individual vehicle. This is necessary for safety reasons, since, in particular in the case of a plurality of vehicles on a track, depending on the distance of the vehicles from one another, sufficient distances can be established again with adjacent vehicles, at least on the one of the vehicles, by the actuation of the electric motor. Since for safety reasons the determined minimum spacing cannot be undershot.

The apparatus 100 further comprises the at least one pair of guide wheels 122 disposed in the accommodation compartment 102 for interfacing with the pair of guide rails 254 of the OMN 250. The guide rails 254, in accordance with an embodiment of the present subject matter, are elongate rails extending downwardly from surface 252B of the I-channels 252 of the OMN 250. In accordance with an embodiment of the present subject matter, each guidewheel 122 includes a reciprocation unit 124 for facilitating selective independent reciprocation of each guidewheel 122 along an operative vertical axis. The selective and independent reciprocation of the guide wheels 122 facilitates the turning of the vehicle 200 along the OMN 250. More specifically, if the driver of the vehicle 200 is faced with an upcoming diversion, the driver may extend the guidewheel on the left side if the driver wishes to turn left while keeping the right guidewheel retracted. Such an operation of maintaining the contact of only the right guidewheel with the guiderail while breaking the contact of the left guidewheel with the corresponding guiderail ultimately guides the vehicle to take the right turn. Similarly, the left guidewheel may be extended if the driver wishes to take a left turn.

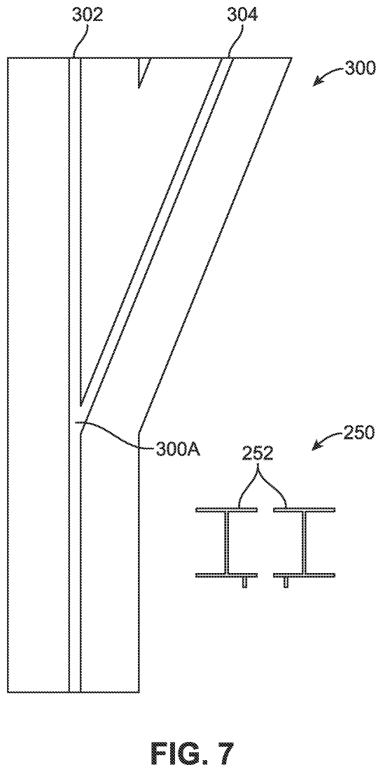

FIG. 7 exemplarily illustrates a schematic view of a diversion 300 occurring on the OMN 250, according to an embodiment of the present disclosure. At junction 300A, the diversion 300 splits into path 302 and path 304. If the driver of vehicle 200 supported on the OMN wishes to go straight and take the path 302, the left guide wheels 122 are required to be maintained in the extended states, whereas if the driver wishes to take the right path 304, only the right guidewheel will remain extended and in contact with the corresponding guiderail, while the left guidewheel may be retracted. Alternatively, instead of utilizing guide wheels to effect switching, electromagnets can magnetically cause switching.

In accordance with an embodiment of the present subject matter, the drive wheel assembly 112 comprises at least one retracting bracket 402 and at least one air bladder 404 for facilitating extension and retraction of the drive wheel assembly 112 out of and into the accommodation compartment 102.

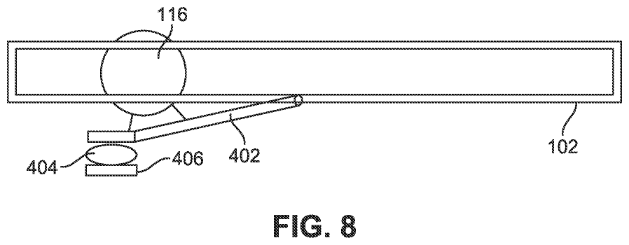

FIG. 8 illustrates a schematic view of retracting brackets and air bladders used in a drive wheel assembly of the apparatus, according to an embodiment of the present disclosure. Referring to FIG. 8, the at least one retracting bracket 402 is pivotally supported in the accommodation compartment 102 and extends into an interior of the wheeled vehicle, wherein the pair of drive wheels 116 and the axle 114 are supported on the retracting brackets 402, in accordance with an embodiment of the present subject matter. In one embodiment, the at least one air bladder 404 is supported on a support beam 406 in the interior of the of the vehicle 200. More specifically, the air bladder 404 is disposed operatively below the retracting bracket 402 for facilitating raising and lowering of the at least one retracting bracket 402 to extend and retract the pair of drive wheels 116 out of and into the accommodation compartment 102. The raising and lowering of the drive wheel assembly 112 via the air bladders 402 is facilitated by inflation and deflation of the air bladders 402, as per the application requirements. Alternatively, linear motors can be used for raising and lowering of the drive wheel assembly 112.

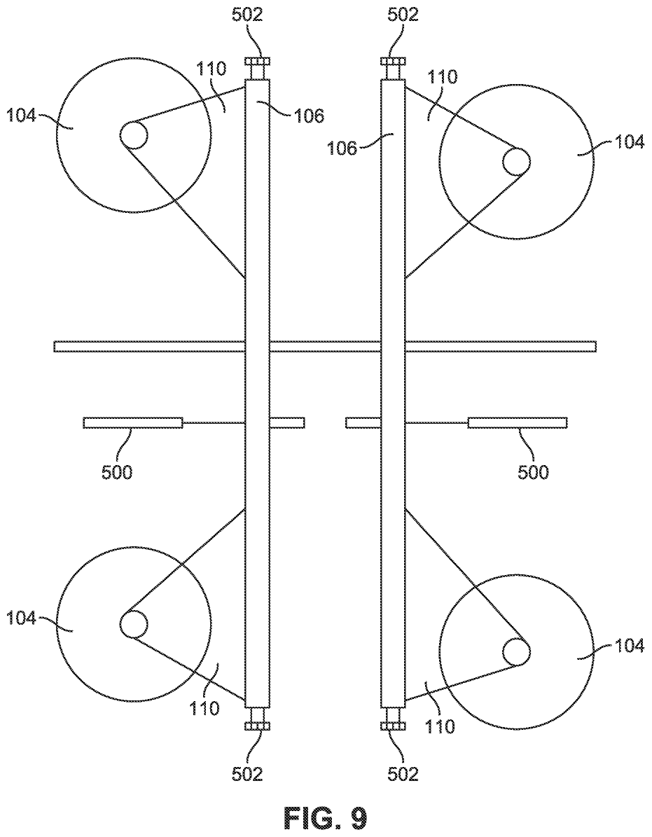

As mentioned previously in the present disclosure, the pair of support wheels 104 are required to be raised and lowered laterally from and into the accommodation compartment 102. To facilitate the raising and lowering of the present support wheels 104, FIG. 9 illustrates a schematic view of linear actuators 500 coupled to the support wheels 104, according to an embodiment of the present disclosure. The pair of linear actuators 500 are disposed in the accommodation compartment 102 and coupled to the pair of support rods 106 for providing required rotary drive to the pair of support rods 106 for facilitating movement of the at least one pair of support wheels 104 in an extended operative state and a retracted inoperative state. In one embodiment, bearings 502 may be provided at the operative ends of the support rods 106 to facilitate a smooth and easy rotary movement of the support rods 106 inside the protrusions 108.

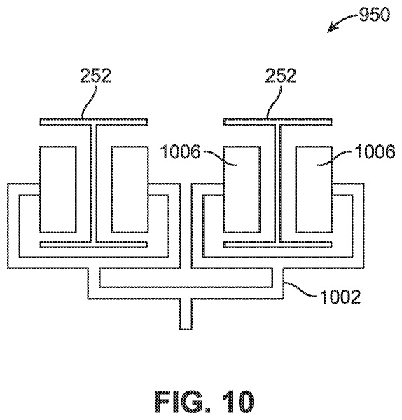

FIG. 10 through FIG. 12 illustrate different views of an apparatus for rail freight transportation, in accordance with an embodiment of the present subject matter. Another embodiment of the invention is implemented in the form of a freight transportation system employing the usage of electrified rails for freight transportation. Conventionally, freight transportation is performed via trucks, which directly contributes to the CO2 and particulate matter air pollution caused by the use of diesel engines of the trucks. Another disadvantageous factor with regard to the conventional freight transportation is that due to the heavy weight of the freight, using electric trucks for transportation may not be the most viable solution because the large battery pack requirements as well as the need of recharging the battery packs at every 300-400 miles.

The present subject matter envisages the use of a rail network of two parallel electric rails (hereinafter interchangeably referred to as rail network) that is configured over the highways, thereby allowing the freight to be supported thereon for intercity or interstate transportation. In another application, the rail network may be configured at ports, where the process of unloading the freight from the ship and loading onto the rail network may be automated. An advantageous factor of such a rail network is that it is an overhead rail network, and as such does not interfere with the floor operations on the ports.

In accordance with the present embodiment, the rail network 950 (as seen in FIG. 10) includes four spaced apart I-channels 252, thereby configuring two electrified rails that define network 950. The rail network 950 comprises four spaced apart I-channels 252 to accommodate the strength requirements associated with the weight for freight transportation.

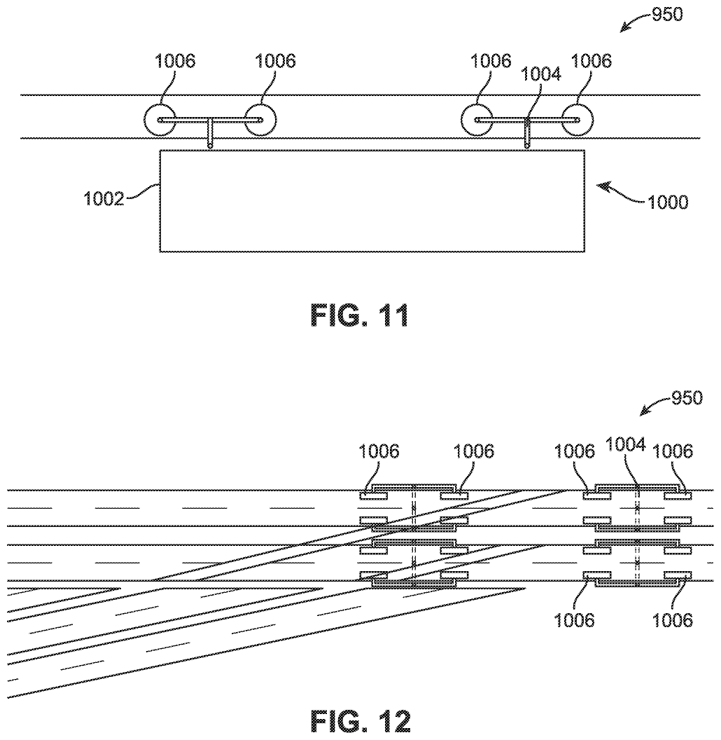

FIG. 11 illustrates a side view of freight transportation system 1000, in accordance with the embodiment of the present subject matter. FIG. 12 illustrates a top view of the freight transportation system 1000, in accordance with the embodiment of the present subject matter. A freight 1002 is mounted on the rail network 950. In one exemplary application, the freight 1002 may be lifted via cable winches or other similar means right from the ships at a port and loaded onto the rail network 950 via at least one bogie 1004 provided on the operative top end of the freight 1002. In one embodiment, the at least one bogie may be extendable and retractable, similar to how support wheels 104 are extended and retracted. In another embodiment, the freight 1002 may also include guide wheels similar to the guide wheels 122 for facilitating turning of the freight along diversions.

In one embodiment, the bogie 1004 may include motor wheels for propulsion. In another embodiment, the bogie 1004 may include support wheels 1006 that is configured to be supported on the rail network 950. In one embodiment, one bogie 1004 may include four support wheels 1006, and one freight may include four such bogies 1004. As such, a single freight 1002 may be supported on sixteen support wheels 1006, in accordance with an embodiment of the present subject matter. In one embodiment, the rail network 950 is an electrified rail network that can power the bogies 1004 for facilitating the freight transportation.

Although it is contemplated that vehicle 200 will be adapted to travel on standard road surfaces under its own power independent of monorail network 250, as will be readily appreciated by those skilled in the art, vehicle 200 may be manufactured without these features. In this aspect of the invention, vehicle 200 may travel along monorail network 250 supported by support wheels 104 and propelled by drive wheels 116. However, a separate vehicle would be required to transport vehicle 200 to and from monorail transportation system if manufactured without separate drive wheels 116. Nevertheless, such a system may be desirable for transporting cargo loads over long distances.

In another aspect of the invention, monorail transportation system may include a computer control system to aid in controlling vehicle 200 during travel along monorail network 250. In one or more embodiments, the monorail transportation system may include one or more remote computers (not shown) and/or an onboard computer mounted in vehicle 200. Onboard computer may include a map of the monorail network for the entire country, along with preset velocities for segments of monorail network 250, electronically stored therein. Additionally, onboard computer may be in a communication with the Global Positioning System (GPS) satellite network. The longitude and latitude of vehicle 200 can be obtained from the GPS, which is then used by onboard computer to determine the location of vehicle 200 on monorail transportation system. This in turn may be graphically displayed to the driver or used to control the velocity of vehicle 200 based upon the preset information. To control spacing between vehicles on monorail network 250, each vehicle may include infrared sensors (not shown) linked to onboard computer. As the distance between the vehicles drops below a preset value, onboard computer reduces the velocity of vehicle 200 accordingly. This information (i.e., vehicle location and velocity) may be relayed to a remote computer through a cellular phone, radio link, or any other communication system. The remote computer may then relay this traffic information to the onboard computers of other vehicles on the system for providing traffic information to drivers or for automatic rerouting of vehicles.

In one or more embodiments, if a hazard is observed on an upcoming portion of the rails by the sensor system of the wheeled vehicle 200, the control system may be configured to automatically respond to that hazard (e.g., by slowing down, stopping, etc.) and to cause each of the other wheeled vehicles to respond in a similar manner. In another example, the sensor system may observe signage for a location, junction, etc. and then, in response to that information, the control system makes an appropriate response (e.g., turn left, turn right) that is based on the destination of the wheeled vehicle 200. In some embodiments, the observations by the sensor system of the wheeled vehicle 200 is wirelessly transmitted to other wheeled vehicles using the overhead monorail network 250.

In one or more embodiments, the wheeled vehicle 200 is configured to, during operation, steer, accelerate, and decelerate on an autonomous basis. In another embodiment of the disclosed technology, the system further includes means for maintaining directional control of the vehicle upon failure of the autonomous steering. In one embodiment, the wheeled vehicle 200 comprises an autonomous control system configured to autonomously move the vehicle through the overhead monorail network 250. In one or more embodiments, the autonomous control system comprises a control unit, which can control the operation of the vehicle 200 on both a partially-autonomous basis, and a fully-autonomous basis. When operating on a partially-autonomous basis, the control unit can control the direction of travel, speed, and braking of the vehicle 200; overall control of vehicle navigation, including turning onto different streets, entering and exiting highways, changing lanes, etc., remains with the driver. The partially-autonomous mode of operation can be used during operation of the vehicle 200 off the overhead monorail network 250. Alternatively, the vehicle 200 can be controlled entirely by the driver when the vehicle 200 is being operated off the overhead monorail network 250. The OMN 250 can be equipped with security measures to enhance the safety, security, and confidence of drivers and passengers. Because the OMN 250 and the vehicles 200 are centrally controlled, it is believed that such security measures can be implemented with relative ease, with little or no inconvenience to drivers and passengers, and with minimal added expense.

When operating on a fully-autonomous basis, the control unit, in conjunction with the central controller of the control system, exercises full control of the position, steering, braking, speed, and navigation of the vehicle 200 via control of the steering mechanism, brakes, and accelerator. This mode of operation is used only when, and whenever the vehicle 200 is being operated on the overhead monorail network 250. Fully autonomous control is feasible under these conditions because the central controller knows the locations, speeds, directions of travel, and destinations of the vehicle 200, and all the other vehicles 200 operating on the overhead monorail network 250. The central controller thus can exercise simultaneous control over all of the vehicles 200 through the respective control units of each vehicle 200. The location, speed, and direction of travel of the vehicle 200 can be sensed by a GPS navigation device, or other suitable means on the vehicle 200; and can be transmitted to the central controller by way of the transceiver and the transceiver. Alternatively, or in addition, the overhead monorail network 250 can be equipped with sensors (not shown) that detect the location, speed, and direction of travel of each vehicle 200, and relay that information to the central controller. Each of the vehicles 200 can be assigned a unique identifier that is transmitted to the central controller, and is used by the controller to track and guide each individual vehicle 200.

In one or more embodiments, the overhead monorail network 250 may include a plurality of active or passive sensors spaced there along. Such sensors may be adapted to the track vehicle 200 traveling along monorail network 250 and relay the information to the central computer or sensors may have indicia formed thereon that provide location information to onboard computer. The onboard computer and the remote computer would be in communication through a cellular phone, radio link, or other communication system. Further, as described above, vehicle 200 may include infrared sensors to control spacing between vehicles on monorail transportation system.

In one or more embodiments, the remote computer and onboard computer may be used to automatically control vehicle 200. The driver would enter a destination location into onboard computer, which would communicate with the remote computer to obtain traffic information. Onboard computer would then select a route and independently, or in conjunction with the remote computer, control vehicle 200 during travel along monorail network 250. Such a computer control system would be particularly beneficial in use with unmanned cargo vehicles. Onboard computer could be programmed with the destination location and it in conjunction with the remote computer system would control vehicle 200 during the travel between the embarkation point and destination. Other variations of this computer control system will be readily apparent to those skilled in the art.

In one or more embodiments, the monorail network 250 generally is maintained at a height such that vehicles traveling there along do not contact the ground. In one embodiment, to mount and dismount vehicle 200 from monorail network 250, the elevation separating monorail network 250 from the ground must be reduced. In one embodiment, a standard road surface is elevated toward monorail network 250 or the monorail network 250 is lowered toward the standard road surface at a mounting/dismounting station such that the distance separating monorail network 250 and road surface is increased/decreased. On exit, the separation distance is reduced to the point where the road surface wheels of a vehicle 200 traveling along monorail network 250 would contact road surface. This separation is maintained in a transition zone generally having a length sufficient to permit vehicle 200 to transition from road travel to monorail travel or from monorail travel to road travel.

After road surface wheels contact road surface, vehicle 200 may transition to traveling under its own power. In one or more embodiments, the support wheels 104 and drive wheels 116 may then be recessed back into the top of vehicle 200. Control of the transition process, including recessing the support wheels 104 and drive wheels 116, may be manual or automatic. For example, proximity switches (not shown) may be used to activate raising and lowering of these components upon entering or exiting the system. However, other means may be used as will be readily appreciated by those skilled in the art. After transitioning to road travel, vehicle 200 is propelled along road surface and vehicle 200 is then driven as a standard road surface vehicle.

In one or more embodiments, to mount monorail transportation system, a reverse procedure is used. Vehicle 200 approaches mounting station where the road surface 150 has been elevated toward monorail network 250. As vehicle 200 enters transition zone, the support wheels 104 and drive wheels 116 are raised to engage lower surface or underside 252B of monorail network 250. The entrance region to transition zone may be similar to that for an automatic car wash to aid in positioning vehicle 200 relative to monorail network 250. Drive wheels 116 are energized and vehicle 200 transitions to being powered by drive motor 120. During travel along monorail network 250, vehicle 200 is powered by drive motor 120, which is operatively interconnected to drive wheels 116. Drive wheels 116 engages lower surface or underside 252B of monorail network 250 to propel vehicle 200 there along. Guide wheels 122 movably engage upper surface 252A of monorail network 250 and freely travel there along. Although mounting station is shown as permitting vehicles to mount and dismount from monorail network 250 at the same location, it will be readily appreciated that mounting station may be modified to permit only mounting to or dismounting from monorail network 250. Such a system would reduce congestion at these locations.

It is contemplated that vehicle 200 will be a relatively lightweight vehicle. As its intended use is generally as a short distance commuting vehicle while unattached from monorail network 250, vehicle 200 is intended to have a road surface speed of approximately 40 miles per hour or more. In one or more embodiments, vehicle 200 may be manufactured from aluminum or other lightweight materials and need not include many of the standard safety features found on high-speed automobiles today. For example, due to the relatively low speeds, heavy bumpers and collision panels may be unnecessary. Further, during travel along monorail network 250, vehicle 200 may be controlled by onboard computer and the central computer system, thereby reducing the likelihood of collisions on monorail transportation system. Further, because vehicle 200 will need travel only relatively short distances while separated from monorail network 250, standard lead-acid batteries will likely be sufficient to provide the necessary electric storage capacity although various rechargeable energy storage battery systems may be used such as at least one of a lithium-ion battery, a lithium iron phosphate battery, a nickel-metal hydride battery, a nickel cobalt aluminum battery, a nickel manganese cobalt battery, an iron-based battery, a sodium-ion battery, a graphene-based battery, a lead-acid battery, and an ultracapacitor.

By virtue of the foregoing, there is thus provided a monorail transportation system that is adapted to support a vehicle there beneath for travel along the monorail wherein the vehicle is capable of traveling on standard road surfaces under its own power. Additionally, the vehicle includes the means for propelling the vehicle along the monorail and draws its power from the monorail system, thereby eliminating vehicle emissions during travel.

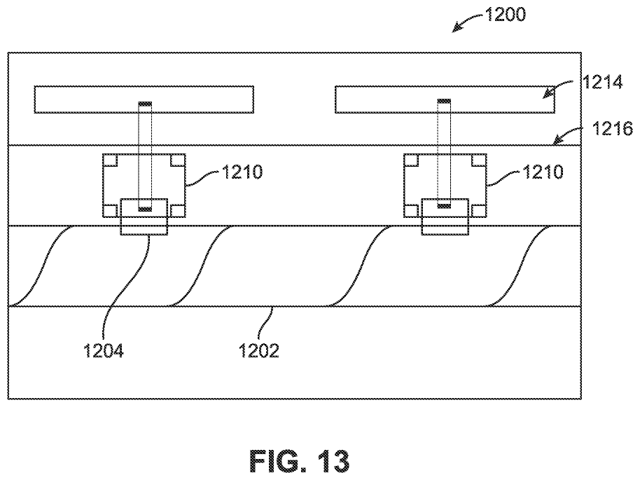

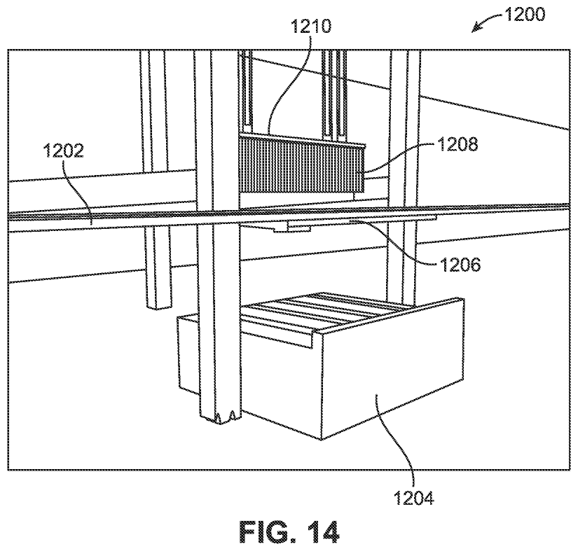

FIG. 13 exemplarily illustrates an environment in a port of an apparatus 1200 for freight transportation, according to an embodiment of the present invention. The apparatus 1200 comprises an electrified rail network 1202, one or more attachment devices 1204, one or more freight carrier 1206 (shown in FIG. 14) and a computing device. The apparatus 1200 optionally utilizes a crane or lift 1210 configured for sideways loading of modules, or shipping containers (SC) 1208 to and from a dock 1216 and onto a surface of a sea vessel 1214, such as a cargo ship or any other marine vessel wherein the crane 1210 comprises a frame for supporting the modules or shipping containers (SC) 1208, the frame comprises a number of conveying beams for conveying module or shipping containers (SC) 1208 in a sideways direction in relation to the frame, and means for lifting in a vertical direction.

In one embodiment, the rail network 950 is an electrified rail network 1202 for facilitating transportation of the freight carrier 1206. The attachment device 1204 is configured to receive shipping containers (SC) 1208 from a crane 1210 to the rail network 1202.

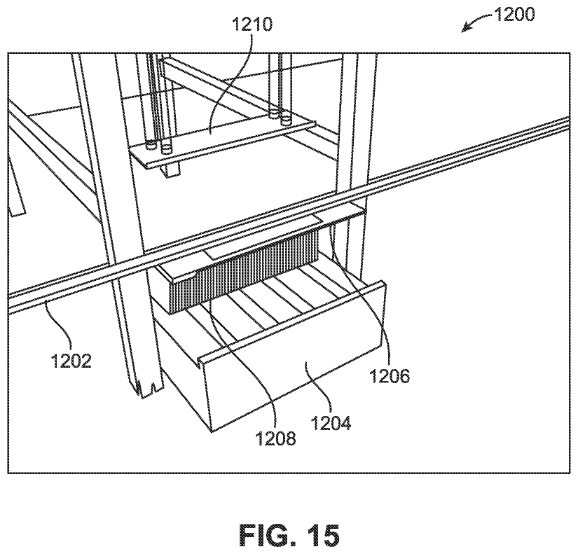

Referring to FIG. 14 and FIG. 15, the attachment device 1204 that connects the shipping container (SC) 1208 from the crane 1210 to the rail network 1202 is attached to the rear legs of the crane 1210 so that the attachment device (AD) 1204 moves along the dock with the crane 1210. The attachment device 1204 is situated directly under the crane 1210 for receiving the shipping container 1208. Thereafter, the attachment device 1204 moves the shipping container 1208 to the exterior of the rear crane legs.

The significance of relocating the shipping container 1208 to the exterior of the rear crane legs lies in several key factors. Firstly, due to the operational limitations preventing the crane 1210 from operating beyond its rear legs, the attachment device 1204 is required to extend between these legs to facilitate the reception of the shipping containers 1208. Additionally, this relocation ensures the preservation of the maximum area under the crane 1210, allowing unimpeded utilization by the current truck delivery system for handling other loads. Furthermore, the positioning of the rail network 1202 within the crane's operational area could potentially obstruct the crane's movement along the rail network 1202, thereby necessitating the relocation of the load to avoid inhibiting the crane's operational maneuverability.

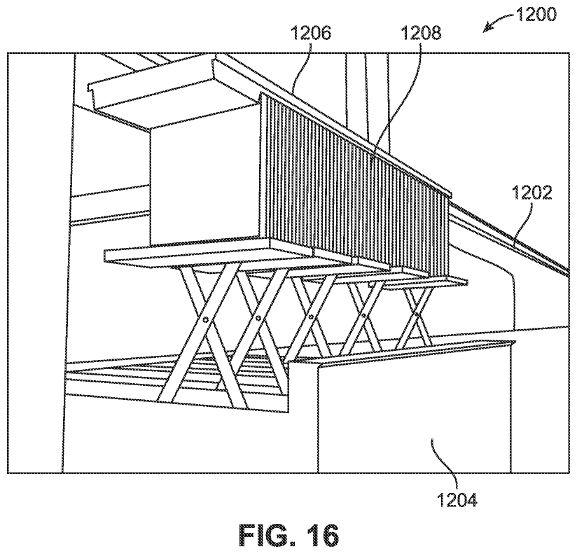

Referring to FIG. 16, the attachment device 1204 is configured to move the shipping container 1208 and positions the shipping container 1208 under the electrified rail network 1202. Further, the freight carrier 1206 moves along the network 1202 to lie directly above the shipping container 1208 on the attachment device 1204. In one embodiment, the freight carrier 1206 has positioning sensors and locking pins on opposing sides of the freight carrier 1206. The freight carrier 1206 is configured to be adjustable to different lengths.

The freight carrier 1206 is configured to adjust the location of the locking pins to match the length of the shipping container 1208. Once the freight carrier 1206 is in position the attachment device 1204 raises the shipping container 1208 so that a connection holes in the top of the shipping container 1208 connect to the locking pins under the freight carrier 1206. Then, the locking pins engage the shipping container 1208.

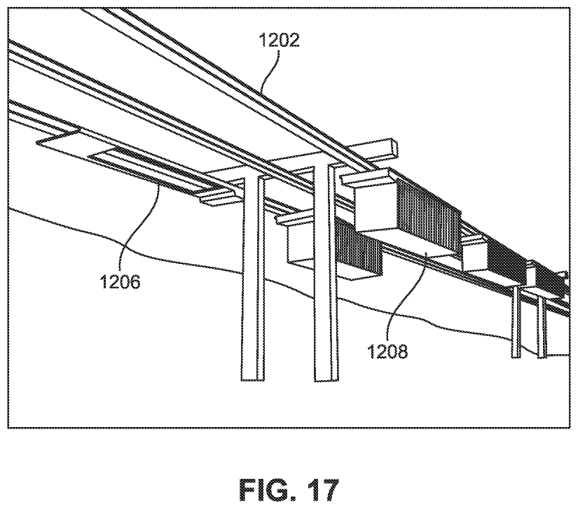

Referring to FIG. 17, the freight carrier 1206 further comprises drive wheel assembly. The drive wheel assembly is disposed at a top portion of the freight carrier 1206. The drive wheel assembly have a similar configuration as that of the drive wheels 116. Thus, the description related to the drive wheels 116 and the rail network 950 discussed in FIG. 1 to FIG. 12 shall be referred for understanding the freight transportation of apparatus 1200. The drive wheel assembly includes an axle, a pair of drive wheels supported on operative ends of the axle, a transmission system coupled to the axle for transmitting a rotary drive to the axle, and a drive motor coupled to the transmission system for providing the rotary drive to the transmission system.

The electrified rail network 1202 has I-beam defining a rail structure or rail tracks. The drive wheels of the freight carrier 1206 are adapted to drive on top of a bottom flange of the track I-beam, which is important for traction. In one embodiment, the electrified rail network 1202 has at least two I-beams. In another embodiment, the electrified rail network 1202 has at least one I-beam. In one embodiment, the electrified rail network 1202 has at least three parallel tracks. The electrified rail network 1202 further comprises one or more mechanical switches. The mechanical switch enables movement of the I-beam. The mechanical switch between the tracks enables the freight carrier 1206 to switch between tracks. If the freight carrier 1206 breaks down at the electrified rail network 1202, the mechanical switch enables the freight carrier 1206 to switch to a different track which bypass the problem.

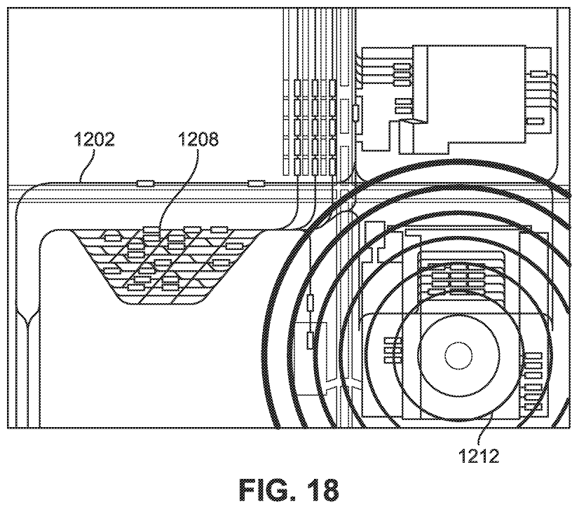

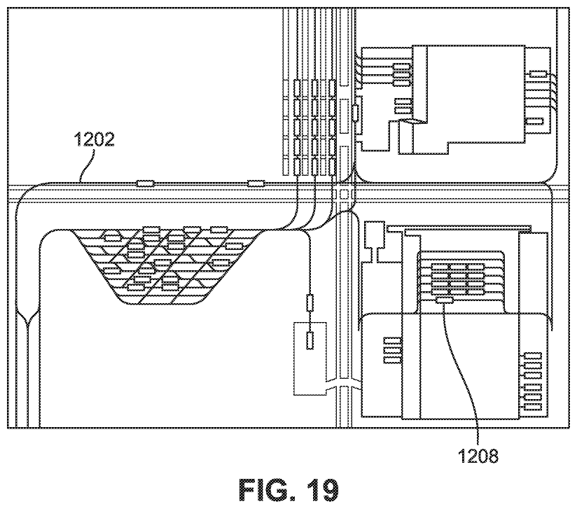

Referring to FIG. 18 and FIG. 19, the apparatus 1200 comprises one or more storage areas. The computing device is configured to communicate with the freight carrier 1206. For example, if the destination point requires the shipping container 1208 to be delivered at a certain period of time (T1), the computing device sends instructions to the freight carrier 1206 to navigate to the storage area and accommodate the storage area temporarily. Thereafter, the computing device is configured to send signal 1212 to the freight carrier 1206 to drop the shipping container 1208 at T1 time. The apparatus 1200 further comprises positioning sensors in communication with the computing device to determine location of the freight carrier 1206 and the shipping container 1208.

For example, due to the temporal mismatch between the arrival of a ship and the readiness of the warehouse or other destination to receive the load, the storage area serves as a holding space where the freight carrier 1206 with attached the shipping container 1208 could be accommodated for multiple days until the warehouse or destination sends a signal 1212 to the freight carrier 1206.

Furthermore, if the designated destination happens to be a warehouse, an automated mechanism is required to reorient the shipping container 1208 so that its rear faces the unloading dock of the warehouse. This adjustment is effortlessly executed via a specialized track spur located in proximity to the warehouse. Once the shipping container 1208 is unloaded, the freight carrier 1206 and shipping container 1208 are sent back to the port. The entire process is reversed with the freight carrier 1206 dropping the empty shipping container 1208 onto the attachment device 1204. The crane 1210 connects to the empty shipping container 1208 and loads it back on the ship.

In another embodiment, an apparatus for freight transportation is disclosed. The apparatus is an automated freight system that silently delivers items into the cities at night or during the day. The apparatus comprising an electrified rail network, at least one attachment device configured to receive a container, at least one freight carrier mounted on the electrified rail network, at least one drive wheel assembly disposed at the freight carrier and at least one computing device. The freight carrier comprises one or more locking pins at opposing sides of the freight carrier. The freight carrier is adjustable in length. The freight carrier is configured to adjust a location of the locking pins to match a length of the container.

The attachment device is configured to move at least one container under the electrified rail network. The attachment device is configured to raise the container so that a connection holes at a top of the container connects to the locking pins under the freight carrier. The drive wheel assembly is configured to provide drive required to facilitate movement of the freight carrier along the electrified rail network. The computing device is in communication with the freight carrier. The computing device is configured to send signal to the freight carrier to navigate the freight carrier to a destination point, thereby automatically delivering containers to the destination point.

The electrified rail network comprises one or more parallel tracks. The electrified rail network comprises one or more spaced apart I-channels that defines the electrified rail network. The apparatus further comprises one or more mechanical switches disposed at the electrified rail network. The mechanical switch is configured to enable the freight carrier to switch between different tracks.

The apparatus further comprises at least one storage area configured to store the freight carrier having the container. The computing device is configured to send signal to the freight carrier to navigate to the storage area and rest at the storage area for a predefined time. The computing device is further configured to send signal to the freight carrier to navigate to a destination point from the storage area at a predefined time, thereby delivering the container at a time desired by a receiver of the container. The computing device is further configured to enable the freight carrier to drop the container at the attachment device of the destination point. The apparatus further comprises positioning sensors in communication with the computing device to determine location of the freight carrier and the container.

The apparatus 1200 operates in a fully automated manner, without any involvement of a human driver involvement. The computing device navigates the freight carrier 1206 to reach to its intended destination. The electrified rail network 1202 facilitates the provision of electricity, resolving the power supply requirement for this apparatus 1200.

Advantageously, the apparatus 1200 enables to carry large Twenty-foot Equivalent Unit. (TEU) containers that come off the ships and transport the container to a destination port or a surrounding destination city. Ports worldwide are actively exploring electric delivery systems as a means to combat global warming and mitigate the significant issue of particulate matter pollution stemming from the extensive use of diesel trucks. The present invention serves as a solution that directly tackles this pressing concern, offering a resolution to the pollution challenges posed by diesel truck operations within port environments.

While the disclosure has been described with reference to exemplary embodiments, it will be understood by those skilled in the art that various changes may be made, and equivalents may be substituted for elements thereof without departing from the scope of the disclosure. In addition, many modifications may be made to adapt a particular system, device, or component thereof to the teachings of the disclosure without departing from the essential scope thereof. Therefore, it is intended that the disclosure is not limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. An apparatus for freight transportation, the apparatus comprising:
an electrified rail network;
at least one attachment device configured to receive a shipping container from a crane;
at least one freight carrier mounted on the electrified rail network, wherein the freight carrier comprises one or more locking pins at opposing sides of the freight carrier, wherein the freight carrier is adjustable in length, wherein the freight carrier is configured to adjust a location of the locking pins to match a length of the shipping container, wherein the attachment device is configured to raise the shipping container so that a connection holes at a top of the shipping container connects to the locking pins under the freight carrier;
at least one drive wheel assembly disposed at the freight carrier, wherein the drive wheel assembly is configured to provide drive required to facilitate movement of the freight carrier along the electrified rail network, and
at least one computing device in communication with the freight carrier, wherein the computing device is configured to send signal to the freight carrier to navigate the freight carrier to a destination point, thereby automatically handling shipping containers at a port.

2. The apparatus of claim 1, wherein the attachment device is configured to move at least one shipping container under the electrified rail network.

3. The apparatus of claim 1, wherein the electrified rail network comprises one or more parallel tracks.

4. The apparatus of claim 1, further comprises one or more mechanical switches disposed at the electrified rail network, wherein the mechanical switch is configured to enable the freight carrier to switch between different tracks.

5. The apparatus of claim 1, further comprises at least one storage area configured to store the freight carrier having the shipping container, wherein the computing device is configured to:
send signal to the freight carrier to navigate to the storage area and rest at the storage area for a predefined time;
send signal to the freight carrier to navigate to a destination point from the storage area at a predefined time, and
enable the freight carrier to drop the shipping container at the attachment device of the destination point.

6. The apparatus according to claim 1, wherein the electrified rail network comprises one or more spaced apart I-channels that defines the electrified rail network.

7. The apparatus according to claim 1, wherein the drive wheel assembly comprises:
an axle supported in the freight carrier;
a pair of drive wheels supported on operative ends of the axle;
a transmission system coupled to the axle for transmitting a rotary drive to the axle; and
a drive motor coupled to the transmission system for providing the rotary drive to the transmission system.

8. The apparatus of claim 1, further comprises positioning sensors in communication with the computing device to determine location of the freight carrier and the shipping container.

9. An apparatus for freight transportation, the apparatus comprising:
an electrified rail network;
at least one attachment device configured to receive a container;
at least one freight carrier mounted on the electrified rail network, wherein the freight carrier comprises one or more locking pins at opposing sides of the freight carrier, wherein the freight carrier is adjustable in length, wherein the freight carrier is configured to adjust a location of the locking pins to match a length of the container, wherein the attachment device is configured to raise the container so that a connection holes at a top of the container connects to the locking pins under the freight carrier;
at least one drive wheel assembly disposed at the freight carrier, wherein the drive wheel assembly is configured to provide drive required to facilitate movement of the freight carrier along the electrified rail network, and
at least one computing device configured to send signal to the freight carrier to navigate the freight carrier to a destination point, thereby automatically delivering containers to the destination point.

10. The apparatus of claim 9, wherein the attachment device is configured to move the container under the electrified rail network.

11. The apparatus of claim 9, wherein the electrified rail network comprises one or more parallel tracks.

12. The apparatus of claim 9, further comprises one or more mechanical switches disposed at the electrified rail network, wherein the mechanical switch is configured to enable the freight carrier to switch between different tracks.

13. The apparatus of claim 9, further comprises at least one storage area configured to store the freight carrier having the container, wherein the computing device is configured to:
send signal to the freight carrier to navigate to the storage area and rest at the storage area for a predefined time;
send signal to the freight carrier to navigate to a destination point from the storage area at a predefined time, thereby delivering the container at a time desired by a receiver of the container, and
enable the freight carrier to drop the shipping container at the attachment device of the destination point.

14. The apparatus of claim 9, further comprises positioning sensors in communication with the computing device to determine location of the freight carrier and the container.
